(19) United States
(12) Patent Application Publication
(10) Pub. No.: US 2009/0077276 A1
(43) Pub. Date: Mar. 19, 2009

(54) DATA TRANSFER DEVICE, INFORMATION PROCESSING SYSTEM, AND COMPUTER-READABLE RECORDING MEDIUM CARRYING DATA TRANSFER PROGRAM

(75) Inventors: Takako Kato, Kawasaki (JP); Terumasa Haneda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/197,497

(22) Filed: Aug. 25, 2008

(30) Foreign Application Priority Data
Sep. 19, 2007 (JP) 2007-242710

(51) Int. Cl. G06F 9/46

(52) U.S. Cl. 710/39

(57) ABSTRACT

A data transfer device connected to data transfer destination via serial attached SCSI includes a plurality of buses. A queuing unit queues processing requests associated with data transfer. A transferring unit obtains data transferred associated with processing request upon receiving processing request and transfer obtained data to the destination by using one of the buses. A transmitting unit transmits processing request queued in the queuing unit to transfer unit. A detecting unit detects the number of processing requests. A determining unit determines whether the number of processing requests detected by the detecting unit is smaller than the number of buses. If the determining unit determines the number of processing requests is smaller than the number of buses, the transmitting unit divides the processing requests into a plurality of processing requests in accordance with the number of buses and the number of processing requests.

### CROSS-REFERENCE TO RELATED APPLICATIONS

This application is related to and claims priority to Japanese patent application no. 2007-242710 filed on Sep. 19, 2007, in the Japan Patent Office, the contents of which are incorporated by reference herein.

### BACKGROUND

1. Field

The present technique relates to a technique for transferring data between devices connected to each other via a SAS (serial attached SCSI (small computer system interface)) Wide Link in response to an I/O (input/output) request.

2. Description of the Related Art

In recent years, a SAS capable of high-rate data transfer has attracted attention as an interface between an initiator device and a target device. The initiator device may be a server or the like as a data transfer source. The target device may be a RAID (redundant arrays of inexpensive disks) device or the like as a data transfer destination. Particularly, a SAS Wide Link enables higher-rate data transfer by connecting devices to each other using a plurality of buses.

For example, referring to FIG. 5, a SAS Wide Link system 100 includes four lanes 102-0 to 102-3 in which a SAS initiator 110 physically connects to a SAS target 120. The SAS initiator 110 physically connects to the SAS target 120 through four buses 101-0 to 101-3. Hereinafter, description is made by using reference numeral 101 when the buses 101-0 to 101-3 are not distinguished from each other. A bus performance of 12 GB/s can be realized if a data transfer rate of a SAS PHY (physical layer) is 3 GB/s in each lane.

Note that the lanes 102-0 to 102-3 (hereinafter description is made by using reference numeral 102 when the lanes 102-0 to 102-3 are not distinguished from each other) are data transfer paths that are realized by SAS PHYs 0 to 3 of the SAS initiator 110 and the SAS target 120 including the respective buses 101. Here, the SAS PHYs 0 of the SAS initiator 110 and the SAS target 120 including the bus 101-0 form the lane 102-0. The SAS PHYs 1 of the SAS initiator 110 and the SAS target 120 including the bus 101-1 form the lane 102-1. The SAS PHYs 2 of the SAS initiator 110 and the SAS target 120 including the bus 101-2 form the lane 102-2. The SAS PHYs 3 of the SAS initiator 110 and the SAS target 120 including the bus 101-3 form the lane 102-3.

If a DMA (direct memory access) manager 111 of the SAS initiator 110 in the SAS Wide Link system 100 receives an I/O request (processing request) issued by a memory controller 103, for example, the DMA manager 111 supplies the I/O request to one of a plurality of DMA channels 112-0 to 112-n. (n is a natural number, preferably 3 to 7, and hereinafter description is made by using reference numeral 112 when the DMA channels 112-0 to 112-n are not distinguished from each other).

When receiving the I/O request, the DMA channel 112 obtains data to be transferred associated with the I/O request and outputs the obtained data. The data output from the DMA channel 112 is transferred to the SAS target 120 through the lane 102 selected by a lane selector 113.

In the SAS target 120, an arbiter 121 arbitrates the transferred data received from the SAS initiator 110 through each lane 102 and transmits it to a reception controller 122. The reception controller 122 outputs a command associated with the received data to a memory controller 104 in accordance with the received data.

Conventionally, there has been a SAS-using technique to absorb a rate difference between a plurality of physical links of a SAS-HDD of a display array device as a target device by using an expander (e.g., see Patent Document 1: Japanese Unexamined Patent Application Publication No. 2006-72636).

### SUMMARY

A data transfer device connected to data transfer destination via serial attached SCSI includes a plurality of buses. A queuing unit queues processing requests associated with data transfer. A transferring unit obtains data transferred associated with processing request upon receiving processing request and transfer obtained data to the destination by using one of the buses. A transmitting unit transmits processing request queued in the queuing unit to transfer unit. A detecting unit detects the number of processing requests. A determining unit determines whether the number of processing requests detected by the detecting unit is smaller than the number of buses. If the determining unit determines the number of processing requests is smaller than the number of buses, the transmitting unit divides the processing requests into a plurality of processing requests in accordance with the number of buses and the number of processing requests.

Additional objects and advantages of the embodiment will be set forth in part in the description which follows, and in part will be obvious from the description, or may be learned by practice of the embodiment. The object and advantages of the embodiment will be realized and attained by means of the elements and combinations particularly pointed out in the appended claims.

It is to be understood that both the foregoing general description and the following detailed description are exemplary and explanatory only and are not restrictive of the embodiment, as claimed.

### BRIEF DESCRIPTION OF THE DRAWINGS

FIG. 1 is a block diagram illustrating a configuration of an information processing system according to an embodiment;

FIG. 2 illustrates a SAS architecture in the information processing system according to an embodiment;

FIG. 3 illustrates an example of a processing request issued by a memory controller of the information processing system according to an embodiment;

FIG. 4 is a block diagram illustrating a schematic configuration of an information processing system according to a modification; and

FIG. 5 is a block diagram illustrating a configuration of a conventional information processing system.

### DETAILED DESCRIPTION OF THE PREFERRED EMBODIMENTS

Hereinafter, an embodiment is described with reference to the drawings. Reference may now be made in detail to embodiments, examples of which are illustrated in the accompanying drawings, wherein like reference numerals refer to like elements throughout.

### About an Embodiment

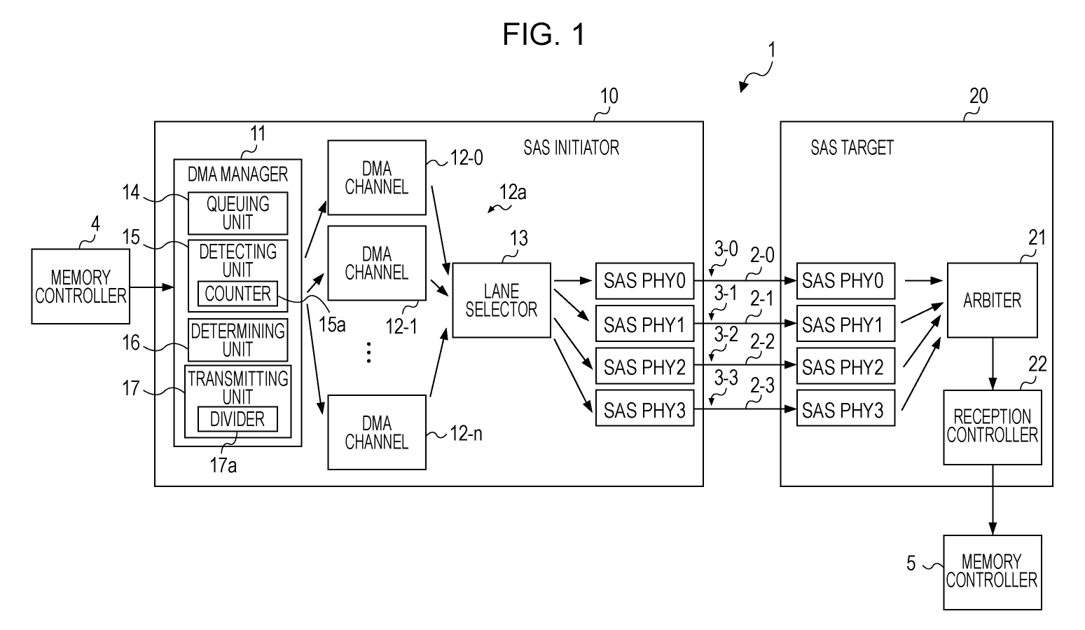

First, an embodiment of a configuration of an information processing system 1 is described with reference to the block diagram illustrated in FIG. 1. As illustrated in FIG. 1, the information processing system 1 includes a SAS initiator device (data transfer device) 10 and a SAS target device (transfer destination) 20. The SAS initiator device 10 and the SAS target device 20 connect to each other via a SAS including a plurality of (in this case, four) buses 2-0 to 2-3 (hereinafter description is made by using reference numeral 2 when the buses 2-0 to 2-3 are not distinguished from each other). Data can be transmitted/received between the devices. A memory controller 4 connects to the SAS initiator device 10. A memory controller 5 connects to the SAS target device 20.

The SAS initiator device 10 is an embodiment of a data transfer device and is a SAS HBA (host bus adapter) of a server, for example. On the other hand, the SAS target device 20 is a SAS HBA of a server, a controller of a RAID device, or a JBOD (just a bunch of disks), for example.

The SAS initiator device 10 and the SAS target device 20 use a four-port SAS Wide Port and physically connect to each other through the four buses 2-0 to 2-3. Accordingly, the SAS realizes four lanes (transfer paths) 3-0 to 3-3 (hereinafter description is made by using reference numeral 3 when the lanes 3-0 to 3-3 are not distinguished from each other).

Here, SAS PHYs (physical layers) 0 of the SAS initiator device 10 and the SAS target device 20 form the lane 3-0 including the bus 2-0. SAS PHYs 1 of the SAS initiator device 10 and the SAS target device 20 form the lane 3-1 including the bus 2-1. SAS PHYs 2 of the SAS initiator device 10 and the SAS target device 20 form the lane 3-2 including the bus 2-2. SAS PHYs 3 of the SAS initiator device 10 and the SAS target device 20 form the lane 3-3 including the bus 2-3.

For example, the data transfer rate of the SAS PHY is 3 GB/s in each lane, and thus the information processing system 1 having four lanes has a bus performance of 12 GB/s.

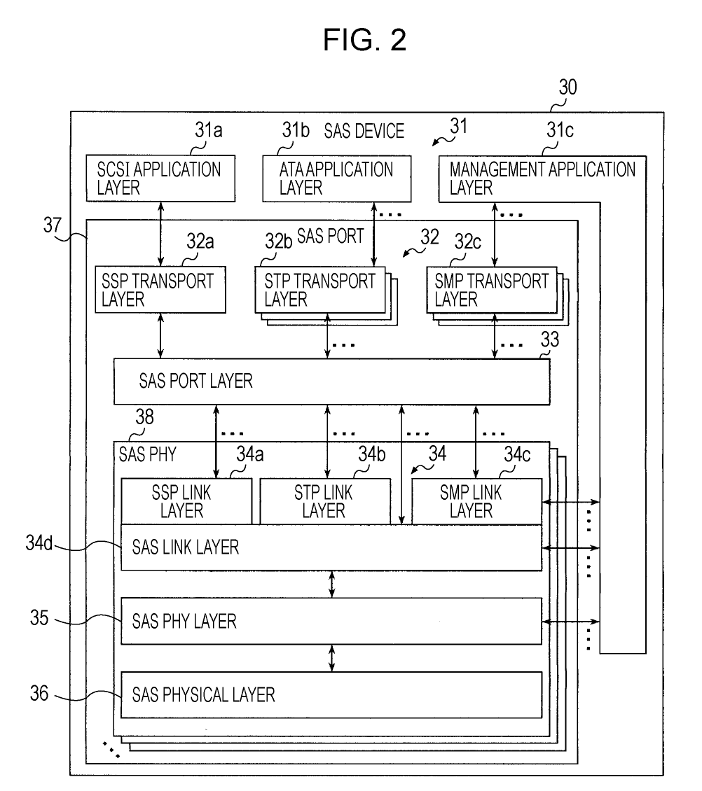

Now, an architecture of the SAS is described with reference to FIG. 2. FIG. 2 illustrates a typical configuration of a SAS architecture. As illustrated in FIG. 2, the SAS architecture includes six layers 31 to 36 in a SAS device 30 (e.g., the SAS initiator device 10 in the information processing system 1).

Specifically, the SAS architecture includes an application layer 31, a transport layer 32, a SAS port layer 33, a link layer 34, a SAS phy layer 35, and a SAS physical layer 36 from the top to the bottom.

The application layer 31 includes an SCSI application layer 31a, an ATA (AT attachment) application layer 31b, and a management application layer 31c, for example.

The transport layer 32 includes an SSP (serial SCSI protocol) transport layer 32a, an STP (SATA tunneling protocol) transport layer 32b, and an SMP (serial management protocol) transport layer 32c, for example.

The link layer 34 includes an SSP link layer 34a, an STP link layer 34b, an SMP link layer 34c, and a SAS link layer 34d, for example.

Here, the transport layer 32, the SAS port layer 33, the link layer 34, the SAS phy layer 35, and the SAS physical layer 36 are included in a SAS port 37.

The number of SAS phys 38, each including the link layer 34, the SAS phy layer 35, and the SAS physical layer 36, corresponds to the number of lanes. For example, the information processing system 1 includes four SAS phys 38.

As illustrated in FIG. 1, the memory controller 4 of the information processing system 1 issues a processing request (IO: input/output) associated with data transfer to the SAS initiator device 10 as a source of data transfer.

On the other hand, the memory controller 5 executes a processing request received by the SAS target device 20 from the SAS initiator device 10 to a storage device or the like in the subsequent stage (not illustrated).

The SAS initiator device 10 transfers a processing request received from the memory controller 4 and data to be transferred associated with the processing request to the SAS target device 20 by using the SAS (the plurality of lanes 3) and includes a DMA (direct memory access) manger 11, DMA channels (obtaining unit) 12-0 to 12-n (n is a natural number, preferably four to eight DMA channels should be provided and thus n is preferably 3 to 7), and a lane selector (selecting unit) 13.

The DMA manger 11 corresponds to the application layer 31 illustrated in FIG. 2 and manages a transfer process and the like about a processing request received from the memory controller 4.

When receiving a processing request from the DMA manager 11, each of the DMA channels 12-0 to 12-n (hereinafter description is made by using reference numeral 12 when the DMA channels 12-0 to 12-n are not distinguished from each other) obtains data to be transferred associated with the processing request and outputs the obtained data toward a transfer destination. The data to be transferred may be data associated with the processing request or the processing request itself.

The number of DMA channels 12 is not limited, and may be four to eight, for example (i.e., n is 3 to 7).

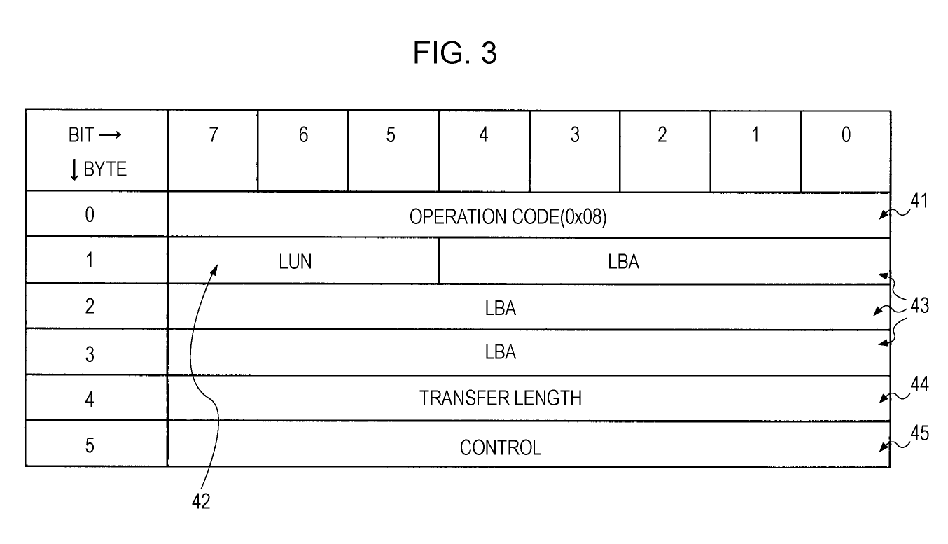

Now, an example of the processing request (in this case, an SCSI read command) is described with reference to FIG. 3. The processing request that is received by the DMA manger 11 from the memory controller 4 and that is supplied to the DMA channel 12 has a structure as illustrated in FIG. 3. That is, the processing request includes an operation code (0×08 in the figure) 41, an LUN (logical unit number) 42, an LBA (logical block address) 43, a transferred-data length (“transfer length” in the figure) 44, and control information (“control” in the figure) 45.

When receiving the processing request illustrated in FIG. 3, the DMA channel 12 obtains data to be transferred from a storage unit (memory, not illustrated) based on the LUN 42 and the LBA 43 and outputs the obtained data together with the processing request to the SAS target device 20 by using the lanes 3 of the SAS.

The lane selector 13 selects the bus 2 to be used for transferring the data output from the DMA channels 12 from among the plurality of buses 2. Specifically, the lane selector 13 selects a vacant one of the buses 2 (lanes 3) as the bus for transferring the data when the data is output from the DAM channels 12. The lane selector 13 also functions as a switch to connect the DMA channel 12 to the selected bus 2 (lane 3).

In this way, the DMA channels 12 and the lane selector 13 function as a transfer unit 12a that obtains data to be transferred associated with a processing request when receiving the processing request associated with data transfer. The transfer unit 12a transfers the obtained data to the SAS target device 20 as a transfer destination by using one of the buses 2 (lanes 3).

As illustrated in FIG. 1, the DMA manager 11 includes a queuing unit 14, a detecting unit 15, a determining unit 16, and a transmitting unit 17.

The queuing unit 14 is a memory based on a FIFO (first-in first-out) method and queues (temporarily holds) processing requests that have been issued by the memory controller 4 and received by the DMA manager 11.

The detecting unit 15 detects the number of processing requests queued in the queuing unit 14 and includes a counter 15a.

Specifically, the detecting unit 15 increments the counter 15a by one when a processing request is input to the queuing unit 14 and decrements the counter 15a by one when a processing request is output from the queuing unit 14. Also, the detecting unit 15 reads the value of the counter 15a so as to detect the number of processing requests queued in the queuing unit 14.

The determining unit 16 determines whether the number of processing requests queued in the queuing unit 14, the number being detected by the detecting unit 15, is smaller than the number of buses 2 connecting the SAS initiator device 10 to the SAS target device 20 (that is, smaller than four, which is the number of SAS lanes 3).

Specifically, if the number of queued processing requests is smaller than the number of buses 2, the determining unit 16 determines that a plurality of the lanes 3 can be used and that a divider 17a of the transmitting unit 17 described below should divide the processing request(s) queued in the queuing unit 14.

The transmitting unit 17 transmits the processing request(s) queued in the queuing unit 14 to the DMA channels 12 (i.e., the transfer unit 12a) in the subsequent stage. The transmitting unit 17 includes the divider 17a that divides the processing request(s) queued in the queuing unit 14 into processing requests in accordance with the number of buses 2 and the number of processing requests queued in the queuing unit 14 if the determining unit 16 determines that the number of processing requests is smaller than the number of buses 2.

That is, the divider 17a divides the queued processing request(s) into a plurality of processing requests in accordance with a difference between the number of buses 2 and the number of queued processing requests so that the number of processing requests after division becomes the same as the number of buses 2.

After the processing request(s) has (have) been divided into a plurality of processing requests by the divider 17a, the transmitting unit 17 transmits all the processing requests generated through division to the DMA channels 12.

On the other hand, if the determining unit 16 determines that the number of processing requests is the same as or larger than the number of buses 2, the divider 17a does not divide the processing requests queued in the queuing unit 14, and the transmitting unit 17 transmits the processing requests queued in the queuing unit 14 to the DMA channels 12 by skipping division. In other words, the transmitting unit 17 allows transfer to be performed by assigning one lane to each processing request in an ordinary SAS transfer method.

Now, a specific dividing process performed by the divider 17a is described. When the number of queued processing requests is one, the divider 17a divides the processing request into four processing requests because the number of buses 2 is four.

When the number of queued processing requests is two, the divider 17a divides each of the processing requests into two processing requests because the number of buses 2 is four.

Furthermore, when the number of queued processing requests is three, the divider 17a divides each of the two processing requests from the head of the queuing unit 14 into two processing requests and outputs them, while the other processing request is not output this time.

Alternatively, when the number of queued processing requests is three, the divider 17a may divide the first processing request in the queuing unit 14 into two processing requests and may output the other two processing requests without dividing them.

Additionally, when the divider 17a divides a processing request, the divider 17a recognizes a transferred-data length associated with the processing request based on the transferred-data length 44 (transferred-data length information) included in the processing request illustrated in FIG. 3, and then divides the processing request based on the recognized data length so that the lengths of transferred data associated with respective processing requests become as even as possible.

More specifically, the divider 17a divides the processing request by changing the LBA 43, which is address information indicating a storage place of transferred data included in the processing request, and the transferred-data length 44.

For example, when a recognized data length is 4 GB and when the number of division is four, the divider 17a generates four processing requests each having a data length of 1 GB. When the LBA 43 of an original processing request before division indicates 1 to 40000, the divider 17a generates four processing requests each having the transferred-data length 44 of 1 GB and sets the LBAs 43 of the respective processing requests to “1 to 10000”, “10001 to 20000”, “20001 to 30000”, and “30001 to 40000”, respectively. In the respective processing requests generated by division, the operation code 41, the LUN 42, and the control information 45 are the same as those in the original processing request.

That is, the divider 17a changes the LBA 43 of the original processing request to “1 to 10000” and also changes the transferred-data length 44 to 1 GB. Then, the divider 17a copies the original processing request to generate three processing requests, changes the respective LBAs 43 to “10001 to 20000”, “20001 to 30000”, and “30001 to 40000”, and also changes the respective transferred-data lengths 44 to 1 GB, thereby dividing the original processing request to four processing requests.

In this way, the DMA manger 11 performs data transfer by using all of the four lanes 3. That is, the determining unit 16 determines neither a processing status of the DMA channels 12 and the lane selector 13 nor an actual usage status of the lanes 3, and estimates a vacant status of the lanes 3 based on the number of lanes 3 and the number of processing requests queued in the queuing unit 14. Based on the estimation result, if the queued processing request(s) can use a plurality of the lanes 3, the transmitting unit 17 (divider 17a) divides the queued processing request(s) so as to use all the lanes 3 in accordance with the number of usable lanes (i.e., the number calculated by subtracting the number of queued processing requests from the number of lanes 3) and the number of queued processing requests. Accordingly, data transfer simultaneously using all the lanes or more lanes constantly can be realized only by providing the detecting unit 15, the determining unit 16, and the divider 17a (here, the functions of the detecting unit 15, the determining unit 16, and the divider 17a are realized by software) without newly providing a mechanism to monitor an actual usage status of vacant lanes 3.

A process in the detecting unit 15, the determining unit 16, and the transmitting unit 17 (divider 17a) of the DMA manager 11 is performed every time the transmitting unit 17 reads a processing request from the queuing unit 14 and transmits it to the DMA channels 12. That is, after the processing request(s) in the queuing unit 14 has (have) been divided by the divider 17a of the transmitting unit 17, the detecting unit 15, the determining unit 16, and the transmitting unit 17 perform a next process after all the processing requests generated by division have been transmitted to the DMA channels 12.

Now, a specific example of an operation procedure of the DMA manager 11 is described. The DMA manager 11 performs the following procedure (1) to (5), for example.

(1) First, the DMA manager 11 receives a processing request from the memory controller 4 in a state where no processing request is queued in the queuing unit 14. The queuing unit 14 queues the processing request and then the counter 15a is incremented by one.

(2) When the transmitting unit 17 performs a transmission process, the detecting unit 15 detects “1”, and the determining unit 16 compares the “1” detected by the detecting unit 15 with the number of buses “4” and determines that the number of queued processing requests is smaller than the number of buses.

(3) Then, the divider 17a of the transmitting unit 17 reads the processing unit from the queuing unit 14 and divides it into four processing requests. The transmitting unit 17 sequentially transmits the four processing requests to the DMA channels 12 in accordance with a processing status of the DMA channels 12. After the processing request has been read from the queuing unit 14, the counter 15a is decremented by one.

(4) If the DMA manager 11 receives another processing request from the memory controller 4 during the above-described operation (3), the processing request is queued in the queuing unit 14 and the counter 15a is incremented by one. If two processing requests are queued during the above-described operation (3), the value of the counter 15a becomes “2”.

(5) Then, after the operation (3) performed by the transmitting unit 17 has ended, the same operations as the above-described operations (2) and (3) are performed. That is, the detecting unit detects “2”, and the determining unit 16 compares the “2” detected by the detecting unit 15 with the number of buses “4” and determines that the number of queued processing requests is smaller than the number of buses. Then, the divider 17a of the transmitting unit 17 reads the two processing requests from the queuing unit 14 and divides each of the two processing requests into two processing requests so as to generate four processing requests. The transmitting unit 17 sequentially transmits the four processing requests to the DMA channels 12 in accordance with a processing status of the DMA channels 12.

In the above-described operation (4), if four or more processing requests are queued and if the detecting unit 15 detects “4” or more, the determining unit 16 determines that the number of queued processing requests is the same as or larger than the number of buses, the divider 17a does not perform division, and the transmitting unit 17 reads one of the processing requests from the queuing unit 14 and transmits it to the DMA channel 12, unlike in the above-described operation (5).

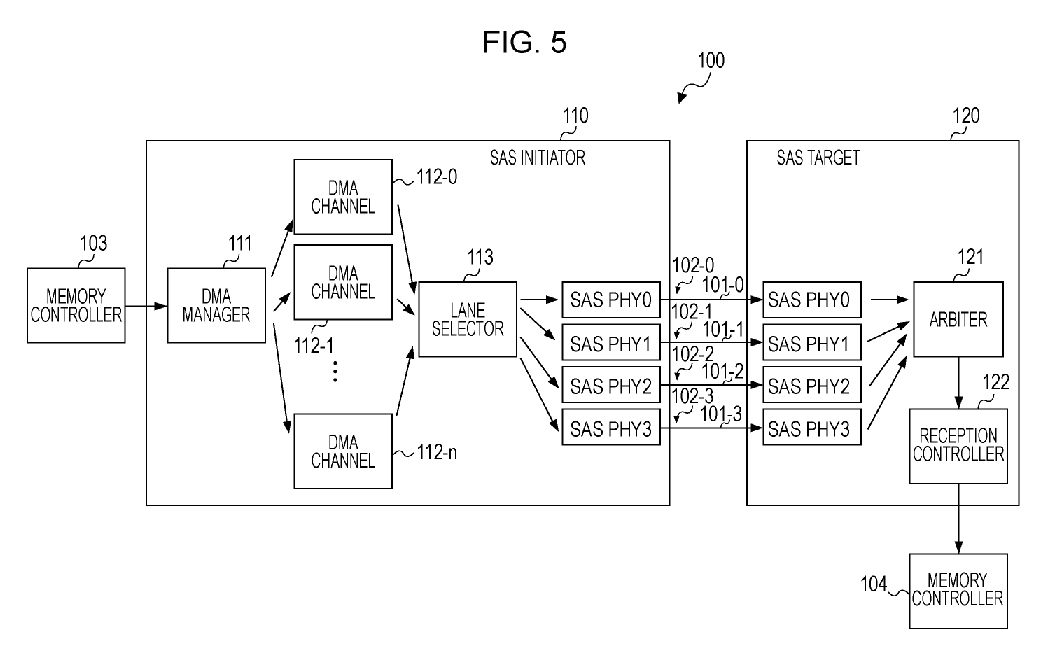

Next, the SAS target device 20 is described. The SAS target device 20 is the same as the SAS target device 120 of the conventional system 100 illustrated in FIG. 5 and includes an arbiter 21 and a reception controller 22.

The arbiter 21 performs arbitration to sequentially transmit processing requests and transferred data received from the SAS initiator device 10 through the SAS lanes 3 to the reception controller 22 in the subsequent stage.

The reception controller 22 outputs a processing request and the like to the memory controller 5 in accordance with a received processing request or a processing request and transferred data.

Then, the memory controller 5 performs a process associated with the processing request (write process/read process) on a storage device (not illustrated) connected to the memory controller 5.

As described above, according to the information processing system as an embodiment the divider 17a of the transmitting unit 17 divides the processing request(s) queued in the queuing unit 14 into a plurality of processing requests, if the determining unit 16 determines that the number of processing requests is smaller than the number of buses 2. The divider 17a divides the processing request(s) in accordance with the number of buses 2 and the number of processing requests queued in the queuing unit 14, so that data transfer using many buses 2 constantly can be realized. Accordingly, data transfer between the SAS devices 10 and 20 mutually connected via the SAS including the plurality of buses 2 can be efficiently performed, and thus higher-rate data transfer can be realized.

That is, the divider 17a of the transmitting unit 17 divides the processing request(s) so as to use all the buses 2 in accordance with the number of processing requests queued in the queuing unit 14. Thus, data transfer according to a related art, in which four buses 2 are provided but only one of the buses 2 is used for one processing request in order to perform data transfer, is not performed. Regardless of a traffic volume, the entire bandwidth of the SAS Wide Link realizing the four lanes 3 (3 GB/s×4 =12 GB/s) can be utilized.

In a comparison with another interface, Ethernet® realizes 10 Gbps in the next generation, whereas FC (fiber channel) realizes 4 Gbps or 8 Gbps in the next generation. Thus a difference in performance between server-to-server and one lane 3 of the SAS (when the performance of one lane 3 is 3 GB/s) becomes large in the future, which will cause a serious bottle neck of the SAS-HBA in the case where data transferred between servers is written in a server local file system. In that case, as in the information processing system 1, a merit of dividing a single processing request to use all the lanes 3 (i.e., realizing a bus performance of 3 GB/s×4=12 GB/s) is further enhanced. This is particularly effective in sequential transfer (e.g., data transfer between servers using an FTP (file transfer protocol)), and a great effect can be expected when a large amount of files are transferred or data is copied in a data mirroring process or the like.

Also, in the information processing system 1, the DMA manager 11 as the application layer 31 in the SAS architecture is an improvement of the conventional one of system 100 illustrated in FIG. 5. That is, the functions of the detecting unit 15, the determining unit 16, and the transmitting unit 17 are added. With this configuration, the SAS initiator device 10 maintains versatility as a SAS device and has the above-described functions, operations, and effects that are realized mainly by improvement of an application. Accordingly, the cost for realizing the SAS initiator device 10 can be suppressed. Also, the function of the DMA manager 11 of the SAS initiator device 10 can be easily added to an existing SAS device at low cost.

Furthermore, if the determining unit 16 determines that the number of processing requests is the same as or larger than the number of buses 2, the transmitting unit 17 transmits the processing requests queued in the queuing unit 14 to the transfer unit 12a by skipping division. Thus, when it can be estimated that all the buses 2 are being used, an ordinary process can be performed while maintaining the usage status.

The divider 17a of the transmitting unit 17 divides the processing request(s) queued in the queuing unit 14 into a plurality of processing request so that the number of processing requests after division becomes the same as the number of buses 2, and the transmitting unit 17 transmits all the divided processing requests to the transfer unit 12a. Accordingly, more efficient data transfer using all the buses 2 can be reliably realized.

When the divider 17a of the transmitting unit 17 divides the processing request, the divider 17a recognizes a transferred-data length associated with the processing request and divides the processing request based on the recognized data length. Accordingly, the processing request can be divided so that the data lengths are even or substantially even in the respective processing requests after division, and thus the buses 2 can be used more efficiently.

At this time, the divider 17a of the transmitting unit 17 recognizes the transferred-data length based on the transferred-data length information 44 included in the processing request, and thus the divider 17a can recognize the transferred-data length reliably and easily.

Furthermore, the divider 17a of the transmitting unit 17 divides the processing request by changing address information (LBA 43) that is included in the processing request and that indicates the storage place of the transferred data and the transferred-data length information 44. Accordingly, the divider 17a can reliably divide the processing request.

### Other Embodiments

The present technique is not limited to the above-described embodiment and can be carried out in various forms without deviating from the scope.

For example, in the above-described embodiment, the SAS initiator device 10 connects to the SAS target device 20 through the four buses 2 (i.e., a four-port SAS Wide Port is provided). In the present technique, however, the number of buses 2 included in the SAS (i.e., the number of SAS lanes 3) is not limited. The number of buses 2 may be 8, 12, 16, 20, or 24, for example.

In the above-described embodiment, even when three processing requests are queued in the queuing unit 14, the divider 17a divides the processing requests. However, the present technique is not limited to such a case. For example, when three processing requests are queued, the determining unit 16 may determine that the divider 17a should not divide the processing requests. In accordance with the determination, the divider 17a does not divide the processing requests, and the transmitting unit 17 may transmit the processing requests to the DMA channels 12.

In the above-described embodiment, the queuing unit 14 and the counter 15a are provided in the DMA manager 11, but the present technique is not limited to this configuration. For example, the queuing unit 14 and the counter 15a may be provided outside the DMA manager 11.

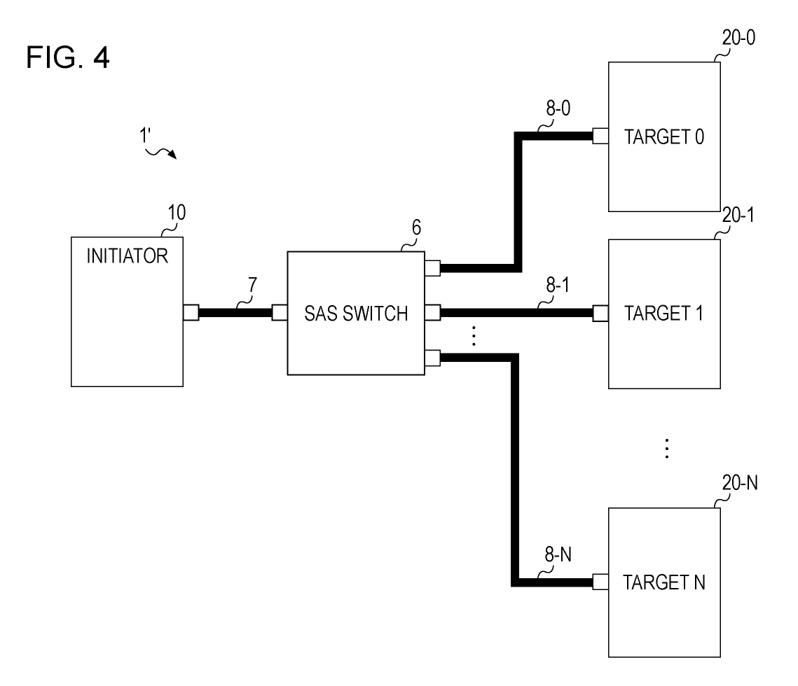

Furthermore, in the above-described embodiment, one SAS target device 20 connects to the SAS initiator device 10. However, the present technique is not limited to this configuration. For example, as in an information processing system 1′ as a modification illustrated in FIG. 4, a plurality of SAS target devices (targets 0, 1, . . . and N) 20-0 to 20-N (N is a natural number) may connect to the SAS initiator device 10 via a SAS switch 6.

In this case, the SAS initiator device 10 connects to the SAS switch 6 through a plurality of buses 7, and the SAS switch 6 connects to the respective SAS target devices 20-0 to 20-N through a plurality of buses 8-0 to 8-N.

With this configuration, the SAS initiator device 10 connects to the respective SAS target devices 20-0 to 20-N via a plurality of lanes by the SAS so that data can be transferred therebetween, and the SAS switch 6 switches the other end of connection (SAS target devices 20-0 to 20-N) of the SAS initiator device 10.

In the information processing system 1′ according to the modification, too, the same operation and effect as those in the above-described embodiment can be obtained.

The functions of the above-described detecting unit 15, the determining unit 16, and the transmitting unit 17 (divider 17a) may be realized when a computer (including a CPU, an information processor, and various terminals) executes a predetermined application program (data transfer program).

The program is provided while being recorded on a computer-readable recording medium, such as a flexible disk, a CD (CD-ROM, CD-R, CD-RW, etc.), or a DVD (DVD-ROM, DVD-RAM, DVD-R, DVD-RW, DVD+R, DVD+RW, etc.). In this case, the computer reads the data transfer program from the recording medium, transfers the program to an internal or external storage device, stores the program therein, and uses the program. Alternatively, the program may be recorded on a storage device (recording medium), such as a magnetic disk, an optical disc, or a magneto-optical disc, and the program may be provided from the storage device to the computer through a communication line.

Here, the computer conceptually includes hardware and an OS (operating system), and is hardware operating under control by the OS. In the case where the OS is unnecessary and where the application program alone operates the hardware, the hardware corresponds to the computer. The hardware includes at least a microprocessor, such as a CPU, and means for reading a computer program recorded on a recording medium.

The application program as the above-described data transfer program includes a program code allowing the above-described computer to realize the functions as the detecting unit 15, the determining unit 16, and the transmitting unit 17 (divider 17a). Furthermore, part of the functions may be realized by the OS, not the application program.

As the recording medium according to this embodiment, various computer-readable media, such an IC card, a ROM cartridge, a magnetic tape, a punch card, an internal storage device (memory such as a RAM or a ROM) or an external storage device of a computer, and a print of a code such as a barcode, may be used as well as the above-described flexible disk, CD, DVD, magnetic disk, optical disc, and magneto-optical disc.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A data transfer device connected to a data transfer destination via a serial attached SCSI including a plurality of buses; the data transfer device comprising:
a queuing unit to queue one or more processing requests associated with data transfer;
a transfer unit to obtain data to be transferred associated with the processing request upon receiving the processing request and transfer the obtained data to the transfer destination by using one of the plurality of buses;
a transmitting unit to transmit the processing request queued in the queuing unit to the transfer unit;
a detecting unit to detect the number of processing requests queued in the queuing unit; and
a determining unit to determine whether the number of processing requests detected by the detecting unit is smaller than the number of buses,
wherein, if the determining unit determines that the number of processing requests is smaller than the number of buses, the transmitting unit divides the processing request queued in the queuing unit into a plurality of processing requests in accordance with the number of buses and the number of processing requests queued in the queuing unit.

2. The data transfer device according to claim 1, wherein, if the determining unit determines that the number of processing requests is the same as or larger than the number of buses, the transmitting unit transmits the processing request queued in the queuing unit to the transfer unit without dividing the processing request.

3. The data transfer device according to claim 1, wherein the transmitting unit divides the processing request queued in the queuing unit into a plurality of processing requests so that the number of processing requests after division is the same as the number of buses.

4. The data transfer device according to claim 1, wherein the transmitting unit recognizes a transferred-data length associated with the processing request when dividing the processing request and divides the processing request based on the recognized data length.

5. The data transfer device according to claim 4, wherein the transmitting unit recognizes the transferred-data length based on transferred-data length information included in the processing request.

6. The data transfer device according to claim 5, wherein the transmitting unit divides the processing request by changing address information indicating a storage place of transferred data and the transferred-data length information included in the processing request.

7. The data transfer device according to claim 1, wherein the transfer unit comprises:
a plurality of obtaining units to obtain data to be transferred associated with the processing request and output the obtained data toward the transfer destination; and
a selecting unit to select a bus to be used for transferring the data output from the obtaining unit from among the plurality of buses.

8. An information processing system including a plurality of information processing devices and a serial attached SCSI to connect the plurality of information processing devices to each other by using a plurality of buses so that data can be transferred between the devices,
the information processing device as a source of transferred data comprising:
a queuing unit to queue one or more processing requests associated with data transfer;
a transfer unit to obtain data to be transferred associated with the processing request upon receiving the processing request and transfer the obtained data to the transfer destination by using one of the plurality of buses;
a transmitting unit to transmit the processing request queued in the queuing unit to the transfer unit;
a detecting unit to detect the number of processing requests queued in the queuing unit; and
a determining unit to determine whether the number of processing requests detected by the detecting unit is smaller than the number of buses,
wherein, if the determining unit determines that the number of processing requests is smaller than the number of buses, the transmitting unit divides the processing request queued in the queuing unit into a plurality of processing requests in accordance with the number of buses and the number of processing requests queued in the queuing unit.

9. The information processing system according to claim 8, wherein, if the determining unit determines that the number of processing requests is the same as or larger than the number of buses, the transmitting unit transmits the processing request queued in the queuing unit to the transfer unit without dividing the processing request.

10. The information processing system according to claim 8, wherein the transmitting unit divides the processing request queued in the queuing unit into a plurality of processing requests so that the number of processing requests after division is the same as the number of buses.

11. The information processing system according to claim 8, wherein the transmitting unit recognizes a transferred-data length associated with the processing request when dividing the processing request and divides the processing request based on the recognized data length.

12. The information processing system according to claim 11, wherein the transmitting unit recognizes the transferred-data length based on transferred-data length information included in the processing request.

13. The information processing system according to claim 12, wherein the transmitting unit divides the processing request by changing address information indicating a storage place of transferred data and the transferred-data length information included in the processing request.

14. The information processing system according to claim 8, wherein the transfer unit comprises:
a plurality of obtaining units to obtain data to be transferred associated with the processing request and output the obtained data toward the transfer destination; and
a selecting unit to select a bus to be used for transferring the data output from the obtaining unit from among the plurality of buses.

15. A computer-readable recording medium carrying a data transfer program allowing a computer to realize a function of executing data transfer associated with a processing request by transmitting the processing request queued in a queuing unit to a transfer unit in a data transfer device that connects to a data transfer destination via a serial attached SCSI using a plurality of buses and that includes the queuing unit to queue one or more processing requests associated with data transfer and the transfer unit to obtain data to be transferred associated with the processing request upon receiving the processing request and transfer the obtained data to the transfer destination by using one of the plurality of buses,
the data transfer program allowing the computer to functions as:
a transmitting unit to transmit the processing request queued in the queuing unit to the transfer unit;
a detecting unit to detect the number of processing requests queued in the queuing unit; and
a determining unit to determine whether the number of processing requests detected by the detecting unit is smaller than the number of buses,
and the data transfer program also allowing the computer to function so that, if the determining unit determines that the number of processing requests is smaller than the number of buses, the transmitting unit divides the processing request queued in the queuing unit into a plurality of processing requests in accordance with the number of buses and the number of processing requests queued in the queuing unit.

16. The computer-readable recording medium carrying the data transfer program according to claim 15, wherein the data transfer program allows the computer to function so that, if the determining unit determines that the number of processing requests is the same as or larger than the number of buses, the transmitting unit transmits the processing request queued in the queuing unit to the transfer unit without dividing the processing request.

17. The computer-readable recording medium carrying the data transfer program according to claim 15, wherein the data transfer program allows the computer to function so that the transmitting unit divides the processing request queued in the queuing unit into a plurality of processing requests so that the number of processing requests after division is the same as the number of buses.
